(19) United States
(12) Patent Application Publication
(10) Pub. No.: US 2024/0182660 A1
(43) Pub. Date: Jun. 6, 2024

(54) PRODUCTION OF POLYURETHANE FOAM

(71) Applicant: Evonik Operations GmbH, Essen (DE)

(72) Inventors: Michael SUCHAN, Gelsenkirchen (DE); Joachim Venzmer, Essen (DE); Jochen Kleinen, Heinsberg (DE); Marc Zimmermann, Potsdam (DE)

(73) Assignee: Evonik Operations GmbH, Essen (DE)

(21) Appl. No.: 18/548,613

(22) PCT Filed: Feb. 24, 2022
(86) PCT No.: PCT/EP2022/054645

§ 371 Date: Sep. 1, 2023

(30) Foreign Application Priority Data
Mar. 2, 2021 (EP) 21160166.1

(51) Int. Cl. C08J 9/00; C08G 18/18; C08G 18/22; C08G 18/42; C08G 18/48; C08G 18/76; C08K 3/02; C08K 3/32; C08K 5/3492

(52) U.S. Cl. CPC C08J 9/0028; C08G 18/18; C08G 18/225; C08G 18/4211; C08G 18/4829; C08G 18/7664; C08J 9/0066; C08K 3/02; C08K 3/32; C08K 5/34922; C08K 5/34924; C08G 2110/0025; C08G 2110/005; C08J 2375/04; C08K 2003/026; C08K 2003/323

(57) ABSTRACT

A composition for producing rigid PU foam contains at least one polyisocyanate component, at least one polyol component, a blowing agent, a solid flame retardant, and optionally, a catalyst that catalyzes the formation of a urethane or isocyanurate linkage. The composition also contains at least one surfactant based on a quaternary ammonium compound.

The present invention relates to the field of polyurethanes, in particular that of polyurethane foams. More particularly, it relates to the production of rigid polyurethane foams using solid flame retardants and surfactants based on quaternary ammonium compounds such as ester quats and/or alkyl quats, to compositions for the production of such foams, and also to the use of said foams. The polyurethane foams here are rigid polyurethane foams.

Polyurethane (PU) in the context of the present invention is in particular understood as meaning a product obtainable through reaction of polyisocyanates and polyols or compounds having isocyanate-reactive groups. Further functional groups in addition to the polyurethane may also be formed in the reaction, for example uretdiones, carbodiimides, isocyanurates, allophanates, biurets, ureas and/or uretonimines. PU is therefore for the purposes of the present invention understood as meaning not just polyurethane, but also polyisocyanurate, polyureas, and polyisocyanate reaction products containing uretdione, carbodiimide, allophanate, biuret and uretonimine groups. In the context of the present invention, polyurethane foam (PU foam) is understood as meaning foam that is obtained as a reaction product based on polyisocyanates and polyols or compounds having isocyanate-reactive groups. In addition to the eponymous polyurethane, further functional groups may also be formed here, for example allophanates, biurets, ureas, carbodiimides, uretdiones, isocyanurates or uretonimines.

A particularly important aim associated with the provision of PU foams, in particular rigid PU foams, is to produce PU foams having good flame-retardant properties. For this reason, flame retardants are used. Flame retardants are substances known per se that are used to limit, slow or prevent the spread of fires. In the known prior art, corresponding flame retardants are described that have flame-retardant properties and are suitable for use in the field of PU foam.

More recently, solid flame retardants such as ammonium polyphosphate (APP) have also been increasingly used in the production of rigid PU foam, since these have ecological and toxicological advantages over liquid, often halogen-containing, flame retardants such as tris(2-chloroisopropyl) phosphate (TCCP). Liquid flame retardants are however much easier to work with. The use of solids gives rise to considerable problems as regards dispersion in liquid feedstocks and processing. These include inter alia sedimentation, redispersion after sedimentation, inhomogeneous distribution in the rigid PU foam and, in particular, a consequent inhomogeneous property profile in the PU foams thus produced. There have been efforts to use dispersing additives to overcome these problems, but so far without really convincing results. Among other things, the use of dispersing additives has each time been accompanied by a sharp increase in the viscosity of the components, making processing significantly more difficult or even impossible.

Against this background, the specific problem addressed by the present invention was that of making it possible to provide rigid PU foams that comprise solid flame retardants, but overcome the abovementioned problems of sedimentation, redispersion after sedimentation and inhomogeneous distribution in the foam, in particular avoiding an excessive increase in the viscosity of the components.

In this regard, it was surprisingly found in the context of the present invention that the use of surfactants based on quaternary ammonium compounds, such as ester quats and/or alkyl quats, permits the desired significant improvement in redispersion and sedimentation stability and also a more homogeneous property profile in the foam. The viscosity of the components is influenced here only to a significantly lesser degree.

The abovementioned problem is solved by the subject matter of the invention. The invention provides a composition for producing rigid PU foam, comprising at least one polyisocyanate component, at least one polyol component, blowing agent, solid flame retardant, optionally a catalyst that catalyses the formation of a urethane or isocyanurate linkage, wherein the composition comprises at least one surfactant based on quaternary ammonium compounds, such as ester quat or alkyl quat or amidoamine quat or imidazolinium quat.

The subject matter of the invention is associated with various advantages. For instance, it makes it possible to provide rigid PU foams having good flame-retardant properties. Advantageously, this is made possible without adversely affecting the other properties of the foam, in particular its mechanical properties. With regard to the provision of rigid PU foams, foam structures that are particularly fine-celled, uniform and low in defects are moreover made possible. It is thus possible to provide corresponding PU foams having particularly good use properties and a homogeneous property profile. The invention makes possible a particularly homogeneous distribution of solid flame retardants in the polyurethane foam. It also makes it possible, if desired, to add a particularly large amount of solid flame retardants to the polyurethane foam. The invention overall makes it possible for solid flame retardants to be handled easily during foam production. The solid flame retardants can be introduced into the reaction mixture in a very straightforward manner together with the surfactant based on quaternary ammonium compounds, such as preferably ester quat and/or alkyl quat, for example via one of the two reaction components (polyol component or polyisocyanate component). Introduction via the polyol component is preferred. Sedimentation problems during storage of the dispersion of reaction component and solid can be significantly reduced or even avoided by the present invention. The invention also permits very good redispersibility of the solid in the event of sedimentation after very long storage, which means that constant stirring or mixing during storage, for example, is no longer necessary. The invention also permits more homogeneous distribution of the solids in the polyurethane foam, which results in a more uniform property profile.

Surfactants based on quaternary ammonium compounds, such as ester quats, amidoamine quats, imidazolinium quats, cetylpyridinium chloride and/or alkyl quats, are known per se to those skilled in the art. For example, ester quats and alkyl quats are surfactants based on quaternary ammonium compounds having at least one long hydrocarbon radical. While alkyl quats are generally tetraalkylammonium salts, ester quats are generally based on quaternary triethanolmethylammonium compounds or quaternary diethanoldimethylammonium compounds esterified with at least one fatty acid.

Alkyl quats and ester quats have long been used in cosmetics or detergents and cleaning agents, e.g. fabric softeners, and the production thereof has long been known to those skilled in the art. Alkyl quats can be produced for example by reaction of the corresponding amine with methylating agents such as chloromethane or dimethyl sulfate. Ester quats can be produced for example by esterification of methyldiethanolamine or triethanolamine with fatty acids followed by quaternization with dimethyl sulfate or chloromethane, for example.

In a particularly preferred embodiment of the invention, the employed surfactant(s) based on quaternary ammonium compounds are preferably at least one ester quat of the formula (1) or (2), an alkyl quat of the formula (3), an imidazolinium quat of the formula (4), an amidoamine quat of the formula (5) and/or cetylpyridinium chloride, wherein in

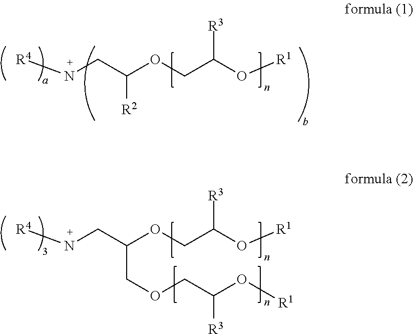

R¹ is an acyl radical of a saturated or mono- or polyunsaturated, linear or branched fatty acid having a chain length of 8 to 22 carbon atoms or the acyl radical of ricinoleic acid, or hydrogen,
it being possible for a compound of the formula (1) or (2) to contain different radicals R¹, and
with the proviso that at least one radical R¹ must be one of the named acyl radicals,
R² is an alkyl radical having 1 to 6 carbon atoms or hydrogen, preferably hydrogen, methyl, ethyl, propyl or isopropyl, more preferably hydrogen or methyl.
R³ is an alkyl radical having 1 to 6 carbon atoms or hydrogen, preferably hydrogen, methyl, ethyl, propyl or isopropyl, more preferably methyl or hydrogen,
R⁴ is an alkyl radical having 1 to 6 carbon atoms or a hydroxyethyl radical or hydrogen, preferably methyl, ethyl, propyl or isopropyl, more preferably ethyl or methyl, very particularly preferably methyl,
it being possible for a compound of the formula (1) or (2) to contain different radicals R⁴, and
n=0 to 20, preferably 0 to 10, more preferably 0,
a=1 to 3 and b=1 to 3,
with the proviso that a+b=4,
and/or wherein in

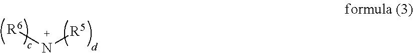

R⁵ is a saturated or mono- or polyunsaturated, linear or branched alkyl radical having a chain length of 8 to 24 carbon atoms,
it being possible for a compound of the formula (3) to contain different radicals R⁵,
R⁶ is an alkyl radical having 1 to 6 carbon atoms or a hydroxyethyl radical or a benzyl radical or hydrogen, preferably methyl, ethyl, propyl, isopropyl or benzyl, more preferably ethyl or methyl, very particularly preferably methyl,
it being possible for a compound of the formula (3) to contain different radicals R⁶, and
c=1 to 3 and d=1 to 3
with the proviso that c+d=4
and/or wherein in

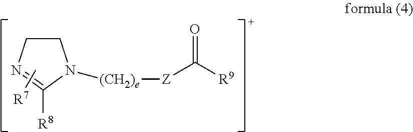

R⁷ is an alkyl radical having 1 to 6 carbon atoms or a hydroxyethyl radical or hydrogen, preferably methyl, ethyl, propyl or isopropyl, more preferably ethyl or methyl, very particularly preferably methyl,
R⁸ is a saturated or mono- or polyunsaturated, linear or branched alkyl radical having 8 to 22 carbon atoms or a radical O(CO)R¹⁰, where R¹⁰ is an aliphatic, saturated or mono- or polyunsaturated, linear or branched alkyl radical having 7 to 21 carbon atoms,
R⁹ is an aliphatic, saturated or mono- or polyunsaturated, linear or branched alkyl radical having 7 to 21 carbon atoms.
Z is an NH group or oxygen,
e can be an integer from 1 to 4,
and/or wherein in

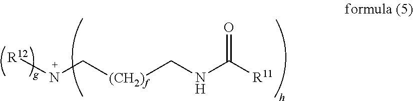

R¹¹ is a saturated or mono- or polyunsaturated, linear or branched alkyl radical having a chain length of 7 to 21 carbon atoms,
R¹² is an alkyl radical having 1 to 6 carbon atoms or a hydroxyethyl radical or hydrogen, preferably methyl, ethyl, propyl or isopropyl, more preferably ethyl or methyl, very particularly preferably methyl,
it being possible for a compound of the formula (5) to contain different radicals R¹², and
f can be an integer from 0 to 5,
h=1 or 2 and g=2 or 3,
with the proviso that h+g=4,
it being possible for a compound of the formula (5) in which h=2 to have different values for f and to contain different radicals R¹¹;
where R₄, R₆, R₇ or R₁₂ comprises a hydroxyethyl radical, these may also be alkoxylated and said optionally alkoxylated hydroxyethyl radical may contain repeat units based on ethylene oxide, propylene oxide, butylene oxide and/or styrene oxide and comprise 1-15 repeat units, preferably 1-10 repeat units.

Corresponding compositions comprising corresponding quaternary ammonium compounds show particularly advantageous results in respect of the above-described advantages of the invention.

It corresponds to a further particularly preferred embodiment of the invention when, in formula (1) and/or formula (2), R¹ is selected from acyl radicals of acids from the group comprising oleic acid, isostearic acid, lauric acid, palmitic acid, elaidic acid, vaccenic acid, gadoleic acid, eicosenoic acid, cetoleic acid, erucic acid, nervonic acid, linoleic acid, alpha-linolenic acid, gamma-linolenic acid, calendic acid, punicic acid, alpha-eleostearic acid, beta-eleostearic acid, arachidonic acid, timnodonic acid, clupanodonic acid and/or cervonic acid.

It is further preferable when, in formula (1), a=b=2 and/or, in formula (5), h=1 and g=3. This likewise corresponds to a further particularly preferred embodiment of the invention.

A composition of the invention comprising at least one counteranion to the compound of the general formula (1), (2), (3), (4) and/or (5) selected from the group comprising chloride, bromide, iodide, alkylsulfate, e.g. methylsulfate, ethylsulfate, alkylsulfonate, e.g. methylsulfonate, triflate, tosylate, phosphate, sulfate, hydrogensulfate, lactate, glycolate, acetate and/or citrate corresponds to a further particularly preferred embodiment of the invention.

A further particularly preferred embodiment of the invention is when surfactants based on a quaternary ammonium compound are present in the composition of the invention in a total amount of 0.1 to 10 parts, preferably 0.1 to 5 parts, more preferably 0.1 to 4 parts, based on 100 parts of polyols.

It is obligatory for the composition of the invention to comprise at least one solid flame retardant. Solid flame retardants employable for use in rigid PU foams are likewise known per se and the present invention is also not limited in the selection of solid flame retardants. It does however correspond to a preferred embodiment of the invention when certain solid flame retardants are used in the composition of the invention, such compositions preferably comprising melamine, melamine cyanurate and/or phosphorus-based flame retardants such as ammonium polyphosphate or red phosphorus. Particular preference is given to using ammonium polyphosphate (APP) [CAS: 68333-79-9].

It is additionally particularly preferable when the composition of the invention comprises, as the solid flame retardant, a mixture of ammonium polyphosphate and melamine, or ammonium polyphosphate coated with or encased in melamine, or ammonium polyphosphate microencapsulated with melamine or with melamine-formaldehyde resin.

In a further preferred embodiment of the invention, the solid flame retardant is present in the composition of the invention in a total amount of 1 to 60 parts, preferably 5 to 50 parts, more preferably 8 to 30 parts, based on 100 parts of polyols.

It is additionally particularly preferable when the composition of the invention additionally comprises at least one foam stabilizer, preferably one based on a polyether siloxane, in amounts of 0.5 to 4 parts based on 100 parts of polyols. Foam stabilizers, preferably based on a polyether siloxane, are known per se. Suitable foam stabilizers are described hereinbelow.

The invention further provides a process for producing rigid PU foams based on foamable reaction mixtures comprising polyisocyanates, at least one polyol component, blowing agent, solid flame retardant, optionally a catalyst and optionally other additives, wherein at least one surfactant based on quaternary ammonium compounds, preferably as described above, is used, preferably with the use of a composition of the invention as described above, in particular as described above in more detail in the preferred embodiments.

The process of the invention for producing PU foams can be executed by the known methods, for example by manual mixing or preferably by means of foaming machines. If the process is carried out by using foaming machines, it is possible to use high-pressure or low-pressure machines. The process of the invention can be carried out either batchwise or continuously.

A particularly preferred rigid PU foam formulation for the purposes of the present invention gives a foam density of 5 to 900 kg/m³ and has the composition shown in Table 1, which corresponds to a particularly preferred embodiment of the invention:

TABLE 1
Composition of a preferred rigid PU foam formulation

| | Proportion |
|---|---|
| Component | by weight |
| Polyol | >0 to 99.9 |
| Surfactant(s) based on quaternary ammonium compounds, | 0.1 to 10 |
| preferably according to formula (1), (2), (3), (4) and/or (5) | |
| Solid flame retardant | 1 to 60 |
| Amine catalyst | 0 to 5 |
| Metal catalyst | 0 to 10 |
| Foam stabilizer, preferably polyether siloxane | 0 to 5 |
| Water | 0 to 20 |
| Blowing agent | >0 to 40 |
| Other additives | 0 to 300 |

Isocyanate index: 10 to 1000

For further preferred embodiments and configurations of the process of the invention, reference is also made to the details already given above in connection with the composition of the invention.

The present invention still further provides a rigid PU foam produced by the process of the invention mentioned above, in particular using a composition of the invention.

It is a preferred embodiment of the invention when the PU foam, in particular rigid PU foam, of the invention has a foam density of 5 to 900 kg/m³, preferably 3 to 350 kg/m³, in particular 10 to 200 kg/m³.

The present invention further relates to the use of rigid PU foam of the invention, as mentioned above, as an insulating material and/or as a construction material, especially in construction applications, especially in spray foam or in the refrigeration sector, as acoustic foam for sound absorption, as packaging foam, as headliner for automobiles or pipe jacketing for pipes.

The invention further provides for the use of surfactants based on quaternary ammonium compounds, in particular as defined above by formulas (1), (2), (3), (4) and/or (5), in the production of rigid PU foams comprising solid flame retardants, particularly when using a composition of the invention, in particular as defined in any of the claims. Preference is given to using surfactants based on quaternary ammonium compounds, such as ester quats or alkyl quats, as dispersing additive in the production of rigid PU foams comprising solid flame retardants, in particular to improve the dispersibility, redispersibility and/or sedimentation stability of solid flame retardants in compositions for the production of rigid PU foam.

A preferred composition of the invention comprises the following constituents:
a) surfactant(s) based on quaternary ammonium compounds, in particular as defined above by formula (1), (2), (3), (4) and/or (5)
b) isocyanate-reactive components, in particular polyols
c) at least one polyisocyanate and/or polyisocyanate prepolymer
d) a catalyst that accelerates/controls the reaction of polyols b) with isocyanates c)
e) optionally foam stabilizers
f) one or more blowing agents
g) solid flame retardant
h) optionally further additives, fillers, liquid flame retardants, etc.

Polyols suitable as the isocyanate-reactive component/polyol component b) are for the purposes of the present invention all organic substances having two or more isocyanate-reactive groups, preferably OH groups, and also formulations thereof. Preferred polyols are all polyether polyols and/or polyester polyols and/or hydroxyl-containing aliphatic polycarbonates, in particular polyether polycarbonate polyols, and/or polyols of natural origin, known as “natural oil-based polyols” (NOPs), that are customarily used for producing polyurethane systems, in particular polyurethane coatings, polyurethane elastomers or, in particular, PU foams. The polyols typically have a functionality of 1.8 to 8 and number-average molecular weights within a range from 500 to 15 000. It is customary to employ polyols having OH values within a range from 10 to 1200 mg KOH/g.

For production of rigid PU foams, preference is given to using polyols or mixtures thereof, with the proviso that at least 90 parts by weight of the polyols present, based on 100 parts by weight of polyol component, have an OH value greater than 100, preferably greater than 150, in particular greater than 200. The fundamental difference between flexible foam and rigid foam is that a flexible foam shows elastic behaviour and is reversibly deformable. When the flexible foam is deformed by application of force, it returns to its starting shape as soon as the force ceases. Rigid foam is by contrast permanently deformed. In the context of the present invention, rigid PU foam is understood as meaning in particular a foam to DIN 7726:1982-05 that has a compressive strength to DIN 53 421/DIN EN ISO 604:2003-12 of advantageously ≥20 kPa, preferably ≥80 kPa, more preferably ≥100 kPa, further preferably ≥150 kPa, particularly preferably ≥180 kPa. In addition, the rigid PU foam to DIN EN ISO 4590:2016-12 advantageously has a closed-cell content of greater than 50%, preferably greater than 80% and more preferably greater than 90%.

Polyether polyols can be produced by known methods, for example by anionic polymerization of alkylene oxides in the presence of alkali metal hydroxides, alkali metal alkoxides or amines as catalysts and with addition of at least one starter molecule that preferably contains 2 or 3 attached reactive hydrogen atoms, or by cationic polymerization of alkylene oxides in the presence of Lewis acids, for example antimony pentachloride or boron trifluoride etherate, or by double metal cyanide catalysis. Suitable alkylene oxides contain 2 to 4 carbon atoms in the alkylene radical. Examples are tetrahydrofuran, 1,2-propylene oxide and 1,2- or 2,3-butylene oxide; preference is given to using ethylene oxide and 1,2-propylene oxide. The alkylene oxides may be used individually, cumulatively, in blocks, in alternation or as mixtures. Starter molecules used may in particular be compounds having at least 2, preferably 2 to 8, hydroxyl groups, or having at least two primary amino groups in the molecule. Starter molecules used may for example be water, di-, tri- or tetrahydric alcohols, such as ethylene glycol, propane-1,2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines and also melamine, or amines such as aniline, EDA, TDA, MDA and PMDA, more preferably TDA and PMDA. The choice of suitable starter molecule depends on the respective field of application of the resulting polyether polyol in polyurethane production.

Polyester polyols are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably with diols or triols having 2 to 12, more preferably 2 to 6, carbon atoms, preferably trimethylolpropane and glycerol.

Polyether polycarbonate polyols are polyols containing carbon dioxide bound in the form of carbonate. Since carbon dioxide is formed in large amounts as a by-product in many processes in the chemical industry, the use of carbon dioxide as comonomer in alkylene oxide polymerizations is of particular interest from a commercial viewpoint. Partial replacement of alkylene oxides in polyols with carbon dioxide has the potential to distinctly lower costs for the production of polyols. Moreover, the use of CO₂ as comonomer is environmentally very advantageous, since this reaction constitutes the conversion of a greenhouse gas into a polymer. The preparation of polyether polycarbonate polyols by addition of alkylene oxides and carbon dioxide to H-functional starter substances with the use of catalysts has long been known. Various catalyst systems may be employed here: The first generation were heterogeneous zinc or aluminium salts, as described, for example, in U.S. Pat. No. 3,900,424 or U.S. Pat. No. 3,953,383. In addition, mono- and binuclear metal complexes have been used successfully for copolymerization of CO₂ and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

Polyols based on natural oil-based polyols (NOPs) as renewable raw materials for production of PU foams are of increasing interest in the light of the long-term limits on the availability of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of these polyols are now commercially available from various manufacturers (WO 2004/020497, US 2006/0229375, WO 2009/058367). Depending on the base raw material (e.g. soybean oil, palm oil or castor oil) and subsequent processing, polyols having a varying property profile are obtained. It is possible here to distinguish essentially between two groups: a) polyols based on renewable raw materials that are modified such that they can be used to an extent of 100% for production of polyurethanes (WO 2004/020497, US 2006/0229375); b) polyols based on renewable raw materials that, because of the processing and properties thereof, are able to replace the petrochemical-based polyol only in a certain proportion (WO 2009/058367).

A further class of employable polyols is that of “filled polyols” (polymer polyols). A characteristic feature of these is that they contain dispersed solid organic fillers up to a solids content of 40% or more. Employable polyols include SAN, PUD and PIPA polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, formed for example by in-situ reaction of an isocyanate with an alkanolamine in a conventional polyol.

A further class of employable polyols is that of polyols obtained as prepolymers through reaction of polyol with isocyanate in a molar ratio of preferably 100:1 to 5:1, more preferably 50:1 to 10:1. Such prepolymers are preferably made up in the form of a solution in polymer, the polyol preferably corresponding to the polyol used for preparing the prepolymers.

A further class of employable polyols is that of so-called recycled polyols, i.e. polyols obtained from recycling polyurethanes. Recycled polyols are known per se. For instance, polyurethanes can be cleaved by solvolysis, thereby rendering them into a soluble form. Almost all chemical recycling processes for polyurethanes employ such reactions, e.g. glycolysis, hydrolysis, acidolysis or aminolysis, there being a large number of process variants known in the prior art. The use of recycled polyols represents a preferred embodiment of the invention.

A preferred ratio of isocyanate and polyol, expressed as the index of the formulation, that is to say as the stoichiometric ratio of isocyanate groups to isocyanate-reactive groups (e.g. OH groups, NH groups) multiplied by 100, is within a range from 10 to 1000, preferably 40 to 400. An index of 100 represents a molar ratio of reactive groups of 1:1.

The isocyanate components/polyisocyanate components c) used are preferably one or more organic polyisocyanates having two or more isocyanate functions. The polyol components used are preferably one or more polyols having two or more isocyanate-reactive groups, preferably OH groups.

Isocyanates suitable as isocyanate components are for the purposes of the present invention all isocyanates containing at least two isocyanate groups. It is generally possible to use all aliphatic, cycloaliphatic, arylaliphatic and preferably aromatic polyfunctional isocyanates known per se. Particular preference is given to using isocyanates within a range from 40 to 400 mol % relative to the sum total of the isocyanate-consuming components.

Examples that may be mentioned here include alkylene diisocyanates having 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and any desired mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and the corresponding isomer mixtures, and preferably aromatic diisocyanates and polyisocyanates, for example tolylene 2.4- and 2,6-diisocyanate (TDI) and the corresponding isomer mixtures, naphthalene diisocyanate, diethyltoluene diisocyanate, mixtures of diphenylmethane 2,4′- and 2,2′-diisocyanates (MDI) and polyphenyl polymethylene polyisocyanates (crude MDI) and mixtures of crude MDI and tolylene diisocyanates (TDI). The organic diisocyanates and polyisocyanates may be used individually or in the form of mixtures thereof. It is likewise possible to use corresponding “oligomers” of the diisocyanates (IPDI trimer based on isocyanurate, biurets, uretdiones). In addition, the use of prepolymers based on the abovementioned isocyanates is possible.

It is also possible to use isocyanates modified by the incorporation of urethane, uretdione, isocyanurate, allophanate and other groups, which are termed modified isocyanates.

Organic polyisocyanates that are particularly suitable and therefore employed with particular preference are various isomers of tolylene diisocyanate (tolylene 2,4- and 2,6-diisocyanate (TDI), in pure form or as isomer mixtures of varying composition), diphenylmethane 4,4′-diisocyanate (MDI), “crude MDI” or “polymeric MDI” (comprising the 4,4′ isomer and also the 2,4′ and 2,2′ isomers of MDI and products having more than two rings) and also the two-ring product referred to as “pure MDI” that is composed predominantly of 2,4′ and 4,4′ isomer mixtures, and prepolymers derived therefrom. Examples of particularly suitable isocyanates are detailed for example in EP 1712578, EP 1161474, WO 00/58383, US 2007/0072951, EP 1678232 and WO 2005/085310, which are hereby fully incorporated by reference.

d) Catalysts

Catalysts d) suitable for the purposes of the present invention are all compounds able to accelerate the reaction of isocyanates with OH functions, NH functions or other isocyanate-reactive groups. It is possible to employ here the customary catalysts known from the prior art, including for example amines (cyclic, acyclic; monoamines, diamines, oligomers having one or more amino groups), ammonium compounds, metalorganic compounds and/or metal salts, preferably those of tin, iron, bismuth, potassium and/or zinc. In particular, it is possible to use mixtures of more than one component as catalysts.

As an optional component e) it is possible to use foam stabilizers, in particular surface-active silicon-containing compounds. These can optionally be employed to further optimize the desired cell structure and the foaming process. It is possible in the context of the present invention to use especially any Si-containing compounds that promote foam production (stabilization, cell regulation, cell opening, etc.). These compounds are sufficiently well known from the prior art. Particular preference is given to using at least one foam stabilizer based on a polyether siloxane.

Corresponding siloxane structures employable for the purposes of the present invention are described for example in the following patent documents, although these describe use only in conventional PU foams, as moulded foam, mattress, insulation material, construction foam, etc.:

CN 103665385, CN 103657518, CN 103055759, CN 103044687, US 2008/0125503, US 2015/0057384, EP 1520870 A1, EP 1211279, EP 0867464, EP 0867465, EP 0275563. The abovementioned documents are hereby incorporated by reference and are considered to form part of the disclosure-content of the present invention.

The use of blowing agents f) is in principle optional, preferably obligatory, depending on which foaming process is used. It is possible to work with chemical and physical blowing agents. The choice of blowing agent is here strongly dependent on the nature of the system.

Depending on the amount of blowing agent used, a foam having high or low density is produced. For instance, it is possible to produce foams having densities of 5 kg/m³ to 900 kg/m³. Preferred densities are 5 to 350, more preferably 10 to 200 kg/m³, in particular to 150 kg/m³.

Physical blowing agents used may be appropriate compounds having suitable boiling points. It is likewise possible to use chemical blowing agents that react with NCO groups to liberate gases such as water or formic acid. Particularly preferred blowing agents comprise for the purposes of the present invention hydrocarbons having 3, 4 or 5 carbon atoms, hydrofluoroolefins (HFO), hydrohaloolefins and/or water.

Solid flame retardants g) have already been described hereinabove.

Optional additives h) used (e.g. further additives, fillers, liquid flame retardants, etc.) may be any substances known from the prior art that are used in the production of polyurethanes and PU foams in particular, for example crosslinkers and chain extenders, stabilizers against oxidative degradation (called antioxidants), liquid flame retardants, biocides, cell-refining additives, cell openers, solid fillers, antistatic additives, nucleating agents, thickeners, dyes, pigments, colour pastes, fragrances and/or emulsifiers, etc.

Optional liquid flame retardants included in the composition of the invention may be any known liquid flame retardants suitable for production of polyurethane foams. Suitable optional flame retardants are for the purposes of the present invention preferably liquid organophosphorus compounds such as halogen-free organophosphates, e.g. triethyl phosphate (TEP), halogenated phosphates, e.g. tris(1-chloro-2-propyl) phosphate (TCPP) and tris(2-chloroethyl) phosphate (TCEP), and/or organic phosphonates, e.g. dimethyl methanephosphonate (DMMP) or dimethyl propanephosphonate (DMPP). Other optionally employable liquid flame retardants are halogenated compounds, for example halogenated polyols.

The subject matter of the invention was and is described by way of example hereinbelow, without any intention that the invention be restricted to these illustrative embodiments. Where ranges, general formulas or classes of compounds are stated, these are intended to encompass not only the corresponding ranges or groups of compounds explicitly mentioned but also all subranges and subgroups of compounds that can be obtained by extracting individual values (ranges) or compounds. Where documents are cited in the context of the present description, the entire content thereof, particularly with regard to the subject matter that forms the context in which the document has been cited, is fully incorporated into the disclosure content of the present invention. Percentages are unless otherwise stated in percent by weight. Where average values are stated, these are weight averages unless otherwise stated. Where parameters that have been determined by measurement are stated, the measurements have unless otherwise stated been carried out at a temperature of 25° C. and a pressure of 101 325 Pa.

The examples that follow describe the present invention by way of example, without any intention that the invention, the scope of application of which is evident from the entirety of the description and the claims, be restricted to the embodiments specified in the examples.

### EXAMPLES

### Example 1: Sedimentation Stability

The performance comparison was carried out using the formulations shown in Table 2. For this, 100 g of polyol, according to the example, catalysts, water and foam stabilizer were weighed out and mixed with a disc stirrer (diameter 6 cm) at 1000 rpm for 30 s. The compound of the invention was then added and mixed in with a disc stirrer (diameter 6 cm) at 2000 rpm for 30 s. For the reference experiment, the same mixture, but without addition of the compound of the invention, was likewise mixed at 2000 rpm for a further 30 s. Ammonium polyphosphate as a solid flame retardant was then added with the disc stirrer still running at 2000 rpm and mixed in for a further 45 s. The formulations were then transferred to glass vessels and sealed, and the time until complete sedimentation was measured.

TABLE 2
Formulations (composition in parts by weight)

| Formulation | 1 | 2 | 3 | 4 | 5 | 6 | 7 | 8 |
|---|---|---|---|---|---|---|---|---|
| Polyether polyol* | 100 | 100 | | | | | | |
| Polyester polyol 1** | | | 100 | 100 | | | 100 | 100 |
| Polyester polyol 2*** | | | | | 100 | 100 | | |
| Ammonium | 10 | 10 | 10 | 10 | 10 | 10 | 30 | 40 |
| polyphosphate | | | | | | | | |
| Ester quat EQ 1 | 0.5 | 0.5 | 0.5 | 0.5 | 0.5 | 0.5 | 1.5 | 2.0 |
| POLYCAT ® 8^{#} | | 2 | | | | | | |
| POLYCAT ® 5^{#} | | | | 0.5 | | 0.5 | | |
| KOSMOS ® 75^{#} | | | | 4 | | 4 | | |
| TEGOSTAB ® 8491^{##} | | 2.5 | | 2.0 | | 2 | | |
| Water | | 2 | | 0.8 | | 0.8 | | |

*Daltolac ® R 471 from Huntsman,
**Stepanpol ® PS 3152 from Stepan,
***Isoexter ® 4973 from Coim,
^{#}Catalysts from Evonik Operations GmbH
^{##}Polyether siloxane-based foam stabilizer from Evonik Operations GmbH

As a compound of the invention, an ester quat (EQ 1) obtainable by reaction of diisopropanolmethylamine with isostearic acid and oleic acid and subsequent methylation with dimethyl sulfate was used.

TABLE 3
Sedimentation stability

| | Sedimentation stability in h | Sedimentation stability in h |
|---|---|---|
| Formulation | without EQ 1 (reference) | with EQ 1 |
| 1 | 15 | 24 |
| 2 | 12 | 18 |
| 3 | 48 | 72 |
| 4 | 24 | 32 |
| 5 | 48 | 72 |
| 6 | 24 | 32 |
| 7 | 24 | 72 |
| 8 | 72 | >120 |

In all cases a clear improvement in sedimentation stability was achieved compared to the formulation without ester quat.

### Example 2: Redispersibility

For the performance comparison, the extent to which the formulations described in example 1 can be redispersed was checked. This was done by storing all formulations in an upright position at room temperature for 14 days until complete sedimentation of the solids in all cases. The samples were then all redispersed and assessed on the basis of a scale from 1 to 3. In this scale, a score of 1 means that the sample could already be brought back into dispersion by manually shaking the glass vessel for 30 s. A score of 2 means that, although not possible by manual shaking, the sample could be redispersed using an electric laboratory stirrer (500 rpm for 60 s). A score of 3 was awarded to samples in which a very fine, compact sediment had formed that could not be redispersed by the two methods mentioned above.

TABLE 4
Redispersibility

| | Redispersibility | Redispersibility |
|---|---|---|
| Formulation | without EQ 1 (reference) | with EQ 1 |
| 1 | 2 | 1 |
| 2 | 2 | 1 |
| 3 | 3 | 1 |
| 4 | 2 | 1 |
| 5 | 3 | 1 |
| 6 | 2 | 1 |
| 7 | 3 | 1 |
| 8 | 3 | 1 |

In all investigated cases, the compound of the invention achieved a clear improvement in redispersibility. In particular, the use of polyester polyols avoided the formation of a solid, compact sediment.

The invention therefore permits very good redispersibility of the solids in the event of sedimentation after very long storage, which means that constant stirring or mixing, for example, during storage is no longer necessary.

### Example 3: Viscosity

For the performance comparison of processability, the influence on viscosity of the compound of the invention was investigated. The selected base polyol was a polyester polyol from Stepan (Stepanpol® PS 2352). The formulations described in table 5 were produced in analogous manner to the description in example 1. The ester quat selected was the compound EQ 1 of the invention that was described in example 1. The selected reference additive for dispersion was a TEGO® Dispers 1010 from Evonik Operations GmbH. The viscosity was measured at different shear rates using an Anton Paar MCR 302 rheometer (50 mm plate-plate, 0.5 mm gap) at 25° C.

TABLE 5
Viscosity (parts APP and EQ 1 based on 100 parts polyol)

| | Viscosity at a | | Viscosity at a |
|---|---|---|---|
| Formulation | shear rate of 0.2 1/s | | shear rate of 100 1/s |
| Polyol | 3200 | mPa*s | 3180 mPa*s |
| Polyol + 50 parts APP | 12 700 | mPa*s | 6400 mPa*s |
| Polyol + 50 parts APP + | 68 000 | mPa*s | 6700 mPa*s |
| 2.5 pphp reference | | | |
| additive | | | |
| Polyol + 50 parts APP + | 24 000 | mPa*s | 3260 mPa*s |
| 0.5 parts EQ 1 | | | |

The use of the ester quat of the invention increases the viscosity at low shear rates only moderately, whereas customary dispersing additives bring a pronounced increase in viscosity. At higher shear rates it is possible to achieve a clear reduction in viscosity compared to customary dispersing additives. In the present example the viscosity in fact achieves the level of the base polyol. This brings clear advantages in processing and storage with regard to process technology requirements.

### Example 4: Rigid PIR Foam (PIR=Polyisocyanurate)

The following foam formulation was used for the performance comparison:

TABLE 6
Rigid PIR foam formulation

| Component | Proportion by weight |
|---|---|
| Polyester polyol* | 100 |
| Amine catalyst** | 0.6 |
| Potassium trimerization catalyst*** | 3 |
| Surfactant**** | 2 |
| Water | 0.8 |
| Ester quat EQ 1 | 0 or 0.5 |
| APP | 10 or 15 |
| Cyclopentane/isopentane 70:30 | 18 |
| MDI***** | 273 |

*Stepanpol ® PS 3152 from Stepan, OH value 315 mg KOH/g
**POLYCAT ® 5 from Evonik Operations GmbH
***KOSMOS ® 75 from Evonik Operations GmbH
****TEGOSTAB ® B 84504 from Evonik Operations GmbH
*****Polymeric MDI, 200 mPa*s, 31.5% NCO, functionality 2.7.

The comparative foamings were carried out by manual mixing. For this, polyol, catalysts, water, foam stabilizer, optionally ester quat EQ 1, ammonium polyphosphate and blowing agent were weighed into a beaker and mixed with a disc stirrer (diameter 6 cm) at 1000 rpm for 30 s (batch size 500 g). The beaker was reweighed to determine the amount of blowing agent that had evaporated during the mixing operation and this was replenished. The MDI was then added, and the reaction mixture was stirred with the described stirrer at 3000 rpm for 5 s and immediately transferred to a 25 cm×50 cm×7 cm aluminium mould lined with polyethylene film and thermostatted to 60° C.

After 10 min, the foams were demoulded. One day after foaming, the foams were analysed. Surface and internal defects were assessed subjectively on a scale from 1 to 10, where 10 represents an (idealized) defect-free foam and 1 represents a very significantly defective foam. The thermal conductivity coefficient (A value in mW/m-K) was measured on 2.5 cm-thick discs with an instrument of the Hesto Lambda Control type, model HLC X206, at an average temperature of 10° C. in accordance with the specifications of standard EN12667:2001. The fire performance was determined by the small-burner test (B2) in accordance with DIN 4102-1:1998-05.

The results are compiled in the table below:

TABLE 7
Rigid PIR foam

| | Formulation | | | |
|---|---|---|---|---|
| | 10 pphp APP | 10 pphp APP | 15 pphp APP | 15 pphp APP |
| | 0 pphp EQ 1 | 0.5 pphp EQ 1 | 0 pphp EQ 1 | 0.5 pphp EQ 1 |
| Density in | 38.0 | 38.1 | 38.9 | 38.8 |
| kg/m³ | | | | |
| λ value in | 23.2 | 23.1 | 23.6 | 23.7 |
| mW/m · K | | | | |
| Surface | 6.5 | 7.5 | 6.0 | 7.5 |
| Internal | 7.0 | 8.0 | 6.5 | 7.5 |
| defects | | | | |
| Flame | 138 | 135 | 120 | 120 |
| height | | | | |
| in mm | | | | |
| (B2) | | | | |
| Cream | 35 | 33 | 31 | 30 |
| time | | | | |
| in s | | | | |
| Gel time | 83 | 81 | 79 | 80 |
| in s | | | | |
| Rise time | 105 | 102 | 101 | 97 |
| in s | | | | |
| Tack-free | 173 | 173 | 172 | 170 |
| time in s | | | | |

The results show that the relevant foam properties are affected only negligibly or not at all by the compounds of the invention. Through the use of the compounds of the invention, it is moreover possible to achieve a more homogeneous distribution of the solid flame retardant in the foam, which is manifested in a significant improvement in the surface and also in pore structure/internal defects.

### Example 5: Behaviour of Other Compounds According to the Invention

Further compounds according to the invention were compared with noninventive compounds in analogous manner to the procedure described in examples 1 to 4.

The performance comparison was carried out using the formulation shown in Table 8.

TABLE 8
Rigid PIR foam formulation

| Component | Proportion by weight |
|---|---|
| Polyester polyol* | 100 |
| Amine catalyst ** | 0.6 |
| Potassium trimerization catalyst*** | 5 |
| Surfactant**** | 2 |
| Water | 0.8 |
| Compound according to the invention | 0.5 |
| APP | 10 |
| Cyclopentane/isopentane 70:30 | 18 |
| MDI***** | 286 |

*Stepanpol ® PS 3152 from Stepan, OH value 315 mg KOH/g
** POLYCAT ® 5 from Evonik Operations GmbH
***DABCO ® TMR 12 from Evonik Operations GmbH
****TEGOSTAB ® B 84504 from Evonik Operations GmbH
*****Polymeric MDI, 200 mPa*s, 31.5% NCO, functionality 2.7.

The compounds shown in Table 9 were investigated.

TABLE 9
Compounds investigated

| Name | Type | Composition |
|---|---|---|
| Ester quat EQ 1 | Ester quat | See example 1 |
| Ester quat EQ 2 | Ester quat | Methyl, hydroxyethyl, dihydroxyethyl |
| | | oleate ester quat (methylsulfate) |
| Ester quat EQ 3 | Ester quat | Methyl, hydroxyethyl, dihydroxyethyl |
| | | tallowate ester quat (methylsulfate) |
| Ester quat EQ 4 | Ester quat | Methyl, hydroxyethyl, dihydroxyethyl |
| | | palmitate ester quat (methylsulfate) |
| Ester quat EQ 5 | Ester quat | Dimethyl, dihydroxyethyl tallowate |
| | | ester quat (chloride) |
| Alkyl quat AQ 1 | Alkyl quat | Behenyl (C22) trimethylammonium |
| | | chloride |
| Alkyl quat AQ 2 | Alkyl quat | Distearyl dimethylammonium chloride |
| Alkyl quat AQ 3 | Alkyl quat | Ethyl bis(polyethylene glycol)tallyl |
| | | ammonium ethylsulfate |
| | | (total 10 EO units) |
| Alkyl quat AQ 4 | Alkyl quat | Methyl bis(polyethylene oxide)coco |
| | | ammonium chloride |
| | | (total 15 EO units) |
| Alkyl quat AQ 5 | Alkyl quat | Methyl bis(polyethylene oxide)coco |
| | | ammonium methylsulfate |
| | | (total 5 EO units) |
| Imidazolinium | Imida- | Dioleyl imidazolinium quat |
| quat IQ 1 | zolinium | (methylsulfate, R⁷ = methyl, e = 2, |
| | quats | Z = N) |
| Imidazolinium | Imida- | Dipalmityl imidazolinium quat |
| quat IQ 2 | zolinium | (methylsulfate, R⁷ = methyl, e = 2, |
| | quats | Z = N) |
| Amidoamine | Amidoamine | Methyl, polyethylene oxide, dipalm |
| quat AmQ1 | quat | stearin amidoamine quat |
| | | (f = 0, 3.5 EO, methylsulfate) |
| Amidoamine | Amidoamine | Methyl, polyethylene oxide, |
| quat AmQ2 | quat | diisostearin amidoamine quat |
| | | (f = 0, 3.0 EO, methylsulfate) |
| Cetylpyridinium | — | — |
| chloride | | |
| TEGOPREN ® | Silicone quat | Noninventive |
| 6921 | | |
| TEGOTEX ® | Silicone quat | Noninventive |
| 8080 | | |
| TEGO ® | Modified | Noninventive |
| Dispers 652 | derivative | |
| | based on | |
| | tall oil | |
| Thixatrol ® | Modified | Noninventive |
| ST | derivative | |
| | based on | |
| | castor oil | |

The compounds according to the invention were compared with commercially available noninventive surfactants (TEGOPREN® 6921, TEGOTEX® 8080, TEGO® Dispers 652, Thixatrol® ST).

The results for foam properties shown in Table 10 were obtained in analogous manner to the procedure described in example 4.

TABLE 10
Foam properties of rigid PIR foam

| | Density | λ value | Cell structure | Flame |
|---|---|---|---|---|
| | in | in | (surface/internal | height in |
| Compound | kg/m³ | mW/m · K | defects) | mm (B2) |
| Without dispersing | 37.8 | 23.0 | 6.5/7.0 | 130 |
| additive | | | | |
| Ester quat EQ 1 | 38.0 | 22.9 | 7.5/7.5 | 125 |
| Ester quat EQ 2 | 37.9 | 23.2 | 7.0/7.5 | 130 |
| Ester quat EQ 3 | 37.8 | 23.1 | 8.0/8.0 | 135 |
| Ester quat EQ 4 | 38.1 | 23.0 | 7.5/7.5 | 130 |
| Ester quat EQ 5 | 37.7 | 22.9 | 7.0/7.5 | 130 |
| Alkyl quat AQ 1 | 37.9 | 23.3 | 7.0/7.0 | 130 |
| Alkyl quat AQ 2 | 37.6 | 23.1 | 7.5/8.0 | 130 |
| Alkyl quat AQ 3 | 38.2 | 23.1 | 6.5/7.5 | 125 |
| Alkyl quat AQ 4 | 37.4 | 23.0 | 7.0/7.0 | 130 |
| Alkyl quat AQ 5 | 37.8 | 22.8 | 7.5/7.5 | 135 |
| Imidazolinium | 37.9 | 23.0 | 7.0/7.5 | 130 |
| quat IQ 1 | | | | |
| Imidazolinium | 38.0 | 22.9 | 6.5/7.5 | 130 |
| quat IQ 2 | | | | |
| Amidoamine quat | 38.1 | 23.2 | 7.0/7.5 | 128 |
| AmQ1 | | | | |
| Amidoamine quat | 37.9 | 23.2 | 7.0/ 7.5 | 125 |
| AmQ2 | | | | |
| Cetylpyridinium | 38.0 | 23.0 | 6.5/6.5 | 130 |
| chloride | | | | |
| TEGOPREN ® | — | — | 3.0/2.0 (very | — |
| 6921 | | | adversely | |
| | | | affected) | |
| TEGOTEX ® | — | — | Collapse | — |
| 8080 | | | | |
| TEGO ® | 38.0 | 23.2 | 6.0/6.0 | 140 |
| Dispers 652 | | | | |
| Thixatrol ® ST | 38.4 | 23.6 | 6.0/6.0 | 140 |

The results show that the relevant foam properties are affected only negligibly or not at all by the compounds of the invention. Through the use of the compounds of the invention, it is moreover possible to achieve a more homogeneous distribution of the solid flame retardant in the foam, which is manifested in a significant improvement in the surface and also in pore structure/internal defects. The noninventive compounds on the other hand led to a severe coarsening of the foam (TEOGPREN® 6921), to collapse (TEGOTEX® 8080) or showed no improvement in foam structure (TEGO® Dispers 652, Thixatrol® ST).

The results for sedimentation stability, redispersibility and viscosity shown in Table 11 were obtained in analogous manner to the procedure described in examples 1 to 3. Sedimentation stability and redispersibility were determined using the formulation described in Table 8 (without MDI, without cyclo/isopentane). For the determination of viscosity, a formulation consisting of 10 parts of APP, 0.5 parts of dispersing additive and 100 parts of polyester polyol (Stepanpol® PS 3152) was prepared as described in example 1. Viscosity was determined in analogous manner to example 3.

TABLE 11
Dispersing behaviour

| | Sedimen- | | Viscosity | Viscosity |
|---|---|---|---|---|
| | tation | Redispers- | at 0.2 1/s | at 100 1/s |
| Compound | stability | ibility | in Pa*s | in Pa*s |
| Without dispersing | 24 h | 2 | 6.2 | 3.3 |
| additive | | | | |
| Ester quat EQ 1 | 32 h | 1 | 2.8 | 2.6 |
| Ester quat EQ 2 | 32 h | 1 | 8.2 | 2.9 |
| Ester quat EQ 3 | 48 h | 1 | 4.3 | 3.2 |
| Ester quat EQ 4 | 48 h | 1 | 4.5 | 3.4 |
| Ester quat EQ 5 | 72 h | 1 | 6.5 | 3.5 |
| Alkyl quat AQ 1 | 32 h | 1 | 4.4 | 3.1 |
| Alkyl quat AQ 2 | 32 h | 1 | 4.6 | 3.4 |
| Alkyl quat AQ 3 | 32 h | 1 | 4.0 | 2.9 |
| Alkyl quat AQ 4 | 32 h | 1 | 4.6 | 3.2 |
| Alkyl quat AQ 5 | 32 h | 1 | 4.3 | 2.8 |
| Imidazolinium quat | 48 h | 1 | 6.8 | 3.4 |
| IQ 1 | | | | |
| Imidazolinium quat | 32 h | 1 | 6.7 | 3.5 |
| IQ 2 | | | | |
| Amidoamine quat | 72 h | 1 | 4.5 | 3.4 |
| AmQ1 | | | | |
| Amidoamine quat | 32 h | 1 | 6.4 | 3.1 |
| AmQ2 | | | | |
| Cetylpyridinium | 32 h | 1 | 3.6 | 3.1 |
| chloride | | | | |
| TEGOPREN ® 6921 | Not tested, as foam very adversely affected | | | |
| TEGOTEX ® 8080 | Not tested, as foam very adversely affected | | | |
| TEGO ® Dispers 652 | 24 h | 1 | 6.9 | 3.4 |
| Thixatrol ® ST | 18 h | 2 | 9.1 | 3.5 |

In all cases investigated, an improvement in sedimentation stability and in redispersibility was achieved compared to formulations without compounds according to the invention and compared to noninventive surfactants.

In particular, the use of polyester polyols allowed the formation of a solid, compact sediment to be avoided.

The use of the compounds of the invention increases the viscosity at low shear rates only moderately, whereas noninventive compounds bring a pronounced increase in viscosity and therefore make processing more difficult.

1: A composition for producing rigid PU foam, comprising:
at least one polyisocyanate component,
at least one polyol component,
a blowing agent,
a solid flame retardant,
optionally, a catalyst that catalyses the formation of a urethane or isocyanurate linkage, and
at least one surfactant based on a quaternary ammonium compound.

2: The composition according to claim 1, wherein the quaternary ammonium compound is at least one ester quat of the formula (1) or (2), an alkyl quat of the formula (3), an imidazolinium quat of the formula (4), an amidoamine quat of the formula (5) and/or cetylpyridinium chloride,
wherein in 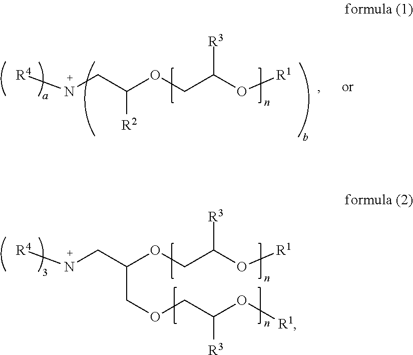
R¹ is an acyl radical of a saturated or mono- or polyunsaturated, linear or branched fatty acid having a chain length of 8 to 22 carbon atoms or the acyl radical of ricinoleic acid, or hydrogen, it being possible for a compound of the formula (1) or (2) to contain different radicals R¹, and with the proviso that at least one radical R¹ must be one of the named acyl radicals,
R² is an alkyl radical having 1 to 6 carbon atoms or hydrogen,
R³ is an alkyl radical having 1 to 6 carbon atoms or hydrogen,
R⁴ is an alkyl radical having 1 to 6 carbon atoms or a hydroxyethyl radical or hydrogen, it being possible for a compound of the formula (1) or (2) to contain different radicals R⁴, and
n=0 to 20,
a=1 to 3 and b=1 to 3,
with the proviso that a+b=4,
and/or
wherein in 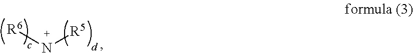
R⁵ is a saturated or mono- or polyunsaturated, linear or branched alkyl radical having a chain length of 8 to 24 carbon atoms, it being possible for a compound of the formula (3) to contain different radicals R⁵,
R⁶ is an alkyl radical having 1 to 6 carbon atoms or a hydroxyethyl radical or a benzyl radical or hydrogen, it being possible for a compound of the formula (3) to contain different radicals R⁶, and
c=1 to 3 and d=1 to 3,
with the proviso that c+d=4,
and/or
wherein in 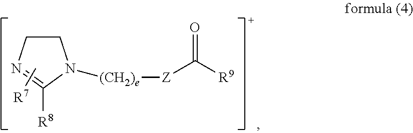
R⁷ is an alkyl radical having 1 to 6 carbon atoms or a hydroxyethyl radical or hydrogen,
R⁸ is a saturated or mono- or polyunsaturated, linear or branched alkyl radical having 8 to 22 carbon atoms or a radical O(CO)R¹⁰, where R¹⁰ is an aliphatic, saturated or mono- or polyunsaturated, linear or branched alkyl radical having 7 to 21 carbon atoms,
R⁹ is an aliphatic, saturated or mono- or polyunsaturated, linear or branched alkyl radical having 7 to 21 carbon atoms,
Z is an NH group or oxygen,
where e is an integer from 1 to 4,
and/or
wherein in 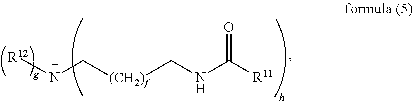
R¹¹ is a saturated or mono- or polyunsaturated, linear or branched alkyl radical having a chain length of 7 to 21 carbon atoms,
R¹² is an alkyl radical having 1 to 6 carbon atoms or a hydroxyethyl radical or hydrogen, it being possible for a compound of the formula (5) to contain different radicals R₁₂, and
f is an integer from 0 to 5,
h=1 or 2 and g=2 or 3,
with the proviso that h+g=4,
it being possible for a compound of the formula (5) in which h=2 to have different values for f and to contain different radicals R¹¹; and
where R⁴, R⁶, R⁷ or R¹² comprises a hydroxyethyl radical which may also be alkoxylated, and said optionally alkoxylated hydroxyethyl radical may contain repeat units based on ethylene oxide, propylene oxide, butylene oxide and/or styrene oxide and comprise 1-15 repeat units.

3: The composition according to claim 2, wherein, in formula (1) and/or formula (2), R¹ is selected from acyl radicals of acids from the group consisting of oleic acid, isostearic acid, lauric acid, palmitic acid, elaidic acid, vaccenic acid, gadoleic acid, eicosenoic acid, cetoleic acid, erucic acid, nervonic acid, linoleic acid, alpha-linolenic acid, gamma-linolenic acid, calendic acid, punicic acid, alpha-eleostearic acid, beta-eleostearic acid, arachidonic acid, timnodonic acid, clupanodonic acids and cervonic acid.

4: The composition according to claim 2, wherein,
in formula (1), a=b=2, and/or
in formula (5), h=1 and g=3.

5: The composition according to claim 2, additionally comprising:
at least one counteranion to compounds of the general formulas (1), (2), (3), (4) and/or (5), selected from the group consisting of chloride, bromide, iodide, alkylsulfate, alkylsulfonate, triflate, tosylate, phosphate, sulfate, hydrogensulfate, lactate, glycolate, acetate, and citrate.

6: The composition according to claim 1, wherein the at least one surfactant based on a quaternary ammonium compound is present in a total amount of 0.1 to 10 parts, based on 100 parts of polyols.

7: The composition according to claim 1, wherein the composition comprises, as the solid flame retardant, ammonium polyphosphate, melamine, melamine cyanurate and/or red phosphorus.

8: The composition according to claim 1, wherein the composition comprises, as the solid flame retardant, ammonium polyphosphate and melamine, or ammonium polyphosphate coated with or encased in melamine, or ammonium polyphosphate microencapsulated with melamine or with melamine-formaldehyde resin.

9: The composition according to claim 1, wherein the solid flame retardant is present in a total amount of 1 to 60 parts, based on 100 parts of polyols.

10: The composition according to claim 1, wherein the composition additionally comprises:
at least one foam stabilizer, in amounts of 0.5 to 4 parts, based on 100 parts of polyols.

11: A process, comprising:
producing a rigid PU foam based on a foamable reaction mixture comprising
at least one polyisocyanate,
at least one polyol component,
a blowing agent,
a solid flame retardant,
optionally, a catalyst,
optionally, other additives, and
at least one surfactant based on a quaternary ammonium compound.

12: A rigid PU foams produced by the process according to claim 11.

13: The rigid PU foam according to claim 12, as wherein the rigid PU foam is an insulating material and/or a construction material.

14: A method, comprising:
producing a rigid PU foam from a composition comprising a solid flame retardant, and with a surfactant based on quaternary ammonium compounds, as a dispersing additive.

15: The method according to claim 14, wherein the surfactant based on quaternary ammonium compounds improves dispersibility, redispersibility, and/or sedimentation stability of the solid flame retardant.

16: The method according to claim 2, wherein in formula (1) or (2),
R² is hydrogen or methyl,
R³ is hydrogen or methyl, and
R⁴ is methyl.

17: The method according to claim 2, wherein in formula (3),
R⁶ is methyl.

18: The method according to claim 2, wherein in formula (4),
R⁷ is methyl.

19: The method according to claim 2, wherein in formula (5),
R¹² is methyl.

20: The composition according to claim 7, wherein the solid flame retardant is ammonium polyphosphate.
